(19) United States
(12) Patent Application Publication
(10) Pub. No.: US 2013/0024222 A1
(43) Pub. Date: Jan. 24, 2013

(54) SYSTEM AND METHOD FOR CONTROLLING ACCESS TO ELECTRONIC LOCKS

(71) Applicant: Stephen Mark Dunn, Broadbeach (AU)

(72) Inventor: Stephen Mark Dunn, Broadbeach (AU)

(73) Assignee: LEAPIN PTY LTD, Adelaide (AU)

(21) Appl. No.: 13/637,620

(22) PCT Filed: Feb. 28, 2012
(86) PCT No.: PCT/AU2012/000198

§ 371 Date: Sep. 26, 2012

(30) Foreign Application Priority Data
Feb. 28, 2011 (AU) 2011900684
Feb. 28, 2012 (AU) PCT/AU2012/000198

(51) Int. Cl. G06Q 10/02

(52) U.S. Cl. 705/5

(57) ABSTRACT

A reservation system for managing access to access controlled locations by issuing an access code that is valid at a particular lock for a particular time. The reservation system includes a standalone lock that has a processor, clock and memory. The processor of the lock checks an access code entered at a given time against the access codes stored in the memory to determine if they are valid for the given time provided by the clock. The reservation system also include a management module that receives a booking and issues an access code. A user interface is provided for a user to interact with the functions of the management module. The invention also includes a method of booking an access controlled location, a method of monitoring an access controlled location, an a standalone lock for an access controlled location.

### FIELD OF THE INVENTION

The present invention relates to reservation systems using electronic locks for controlling access to a location.

### BACKGROUND OF THE INVENTION

The internet has revolutionised and simplified the process of booking accommodation at hotels, holiday homes, and other access controlled locations such as tennis courts. However once the booking is made, the end user must still make contact with the manager, owner or other intermediary who can provide them with the access key to enable the user to access the booked accommodation or facility. This adds an extra level of inconvenience and delay. For example in the case of hotels, the end user must often queue up at the reception desk in order to check-in and receive their access key.

Similarly in relation to facilities such as tennis courts, the end user will typically have to arrange a time to pick up an access key from another location (such as a council office). Further the end user must also arrange to return the access key upon completion of their use of the facility thereby incurring further delay and inconvenience. Additional inconvenience arises if either party is late, or the key is lost.

Similarly this need to physically provide an access key represents an inconvenience to the manager or owner of the accommodation or facility. Hotel managers incur staff costs in maintaining a check-in desk, including ensuring adequate staff are on hand to deal with busy check-in and check-out times. Similarly in the case of holiday houses, the owners often live large distances from the holiday house and thus must appoint a local agent to manage issuing and receiving of access keys, thereby incurring further expense. Further many existing magnetic lock access key systems in use are susceptible to devices which interfere with their magnetic stripes, and are additionally becoming old and unreliable.

There exists therefore a need for a system which would allow guests to book accommodation and then be provided with electronic access which would allow them to go directly to their accommodation without having to interact with the owner or manager, and yet still allow owners to manage their accommodation.

### SUMMARY OF THE INVENTION

According to a first aspect of the present invention, there is provided a system for managing one or more access controlled locations, the system including:
one or more electronic locks for controlling access to one or more locations, each of the one or more electronic locks including:
   input means for receiving an access code;
   a clock;
   a processor and associated memory for verifying a received access code based upon the current time received from the clock; and
   a communications interface for configuring the lock and providing status information;
a management module for managing access to each of the one or more electronic locks, the management module including:
   a management database for storing information relating to the one or more locations, the information including bookings, lock configuration and lock access;
   an access code generator for determining one or more time based access codes for each of the one or more electronic locks based upon configuration data associated with each of the one or more electronic locks;
   a booking module for receiving and storing a booking request from a user for access to a location for a booking time period, the booking module obtaining an access code from the access code generator in response to a received booking request; and
   an access code distribution module for sending the access code to a user;
a user interface for allowing one or more users to interface with the management module, the user interface including:
   an end user interface for receiving a booking request from a user for access to one of the one or more locations for a booking time period; and
   a management interface for viewing and modifying information relating to the one or more locations and for generation of access codes to one or more users.

Preferably the input means is a keypad, although a touch screen would also be suitable.

In one form the associated memory stores a list of access codes and the times they are active. In an alternate form the associated memory stores program instructions to cause the processor to check if an access code is valid according to a predetermined algorithm.

Suitably the communications interface is configured to provide status information on request. The communications interface may be an infrared port or a Bluetooth® port.

The access code generator of the management module may store the same list of access codes and times as the lock. If the access code is generated according to an algorithm the access code generator of the management module will store the same algorithm.

In a further form each of the one or more locks may store the lock access information. The lock access information is provided to the management module upon request via the communications interface. The lock may periodically provide the information to the management module or may provide the information in real time. For real time or periodic provision of information to the management module the communications interface may be a wireless interface using the 802.11 protocol, or similar.

In another form of the invention the management module associates at least one registered user with one of the one or more electronic locks, and sends a lock access report to an associated registered user upon receipt of lock access information for the lock. The lock access report may be sent in the form of a text message to a mobile phone associated with the registered user.

According to a second aspect of the present invention there is provided a method for booking an access controlled location, wherein access to the location is controlled by an electronic lock, the method including the steps of:

receiving a booking request for the access controlled location for a booking time period from a user;

determining an access code for the user to allow the user to access the booked access controlled location for the booking time period; and

sending the access code to the user.

In one form of the second aspect of the invention the access controlled location is selected from the set of one or more available access controlled locations for the booking time period, and the method includes the preliminary steps of:

receiving a search request for access to a location for a booking time period from a user; and

checking the availability of one or more access controlled locations during the booking time period and returning information on one or more available access controlled locations which match the received search request.

According to a third aspect of the present invention there is provided a method for monitoring an electronic lock which allows access to a location using a time based access code, the method including:

logging access information in an electronic lock each time the electronic lock is accessed, wherein the access information relates to the access code and access time;

transferring the access information to a management module which stores contact information for at least one registered user associated with the electronic lock; and

sending a message including the access information to the one or more registered users.

Suitably the step of transferring the access information includes the step of downloading the access information using a short range communication protocol, such as Bluetooth®, and delivering the information to the management module. Alternatively the lock may include a transmitter configured to communicate directly with the management module.

The message may be sent to the one or more registered user over a long range communications means. The message may be a short message service (SMS) message sent over a telecommunications network or the message may be an electronic mail message sent over the internet.

In a further aspect the methods are embodied as instructions in a computer readable medium.

According to a fourth aspect of the present invention there is provided an electronic lock for controlling access to a location, the electronic lock including:
input means for receiving an access code;
a clock;
a processor and associated memory for verifying a received access code based upon the current time received from the clock;
a transmitter for sending access information including the access code and access time to a management module upon the lock being accessed with a valid access code.

In one form of the fourth aspect the input means further includes a receiver for receiving configuration information and the memory contains instructions for generating valid access codes based on the configuration information and current time for comparison with a received access code.

In another form of the fourth aspect the transmitter uses a short range wireless transmission protocol. Such transmission protocols include Bluetooth®, ZigBee®, WiFi, RFID, IEEE 802 standards such as 802.15.4-2006 and Infrared Data Association (IrDA) protocols.

### BRIEF DESCRIPTION OF THE FIGURES

Illustrative embodiment of the present invention will be discussed with reference to the accompanying figures wherein:

FIG. 1 is a schematic diagram of a system for managing one or more access controlled locations according to an embodiment of the invention;

FIG. 2 is a schematic diagram of the management module and user interface of the system of FIG. 1;

FIG. 3 is a flow chart of a method for booking an access controlled location according to an embodiment of the invention;

FIG. 4 is a flow chart of a method for monitoring an electronic lock which allows access to a location using a time based access code according to an embodiment of the invention;

FIG. 5 is a user interface for performing an accommodation search according to an embodiment of the invention;

FIG. 6 is a user interface for displaying the results of an accommodation search according to an embodiment of the invention;

FIG. 7 is a user interface for making a booking request according to an embodiment of the invention;

FIG. 8 is a booking confirmation message including an access code for accessing the booked accommodation during the booking period according to an embodiment of the invention;

FIG. 9 is a management user interface according to an embodiment of the invention;

FIG. 10 is reservation status report according to an embodiment of the invention;

FIG. 11 is a housekeeping and room status report according to an embodiment of the invention;

FIG. 12 is a user interface for configuring property details of managed accommodation according to an embodiment of the invention;

FIG. 13 is a user interface for configuring summary information relating to managed accommodation according to an embodiment of the invention; and

FIG. 14 is a schematic diagram of an electronic lock according to an embodiment of the invention.

In the following description, like reference characters designate like or corresponding parts throughout the figures.

### DESCRIPTION OF ILLUSTRATIVE EMBODIMENT

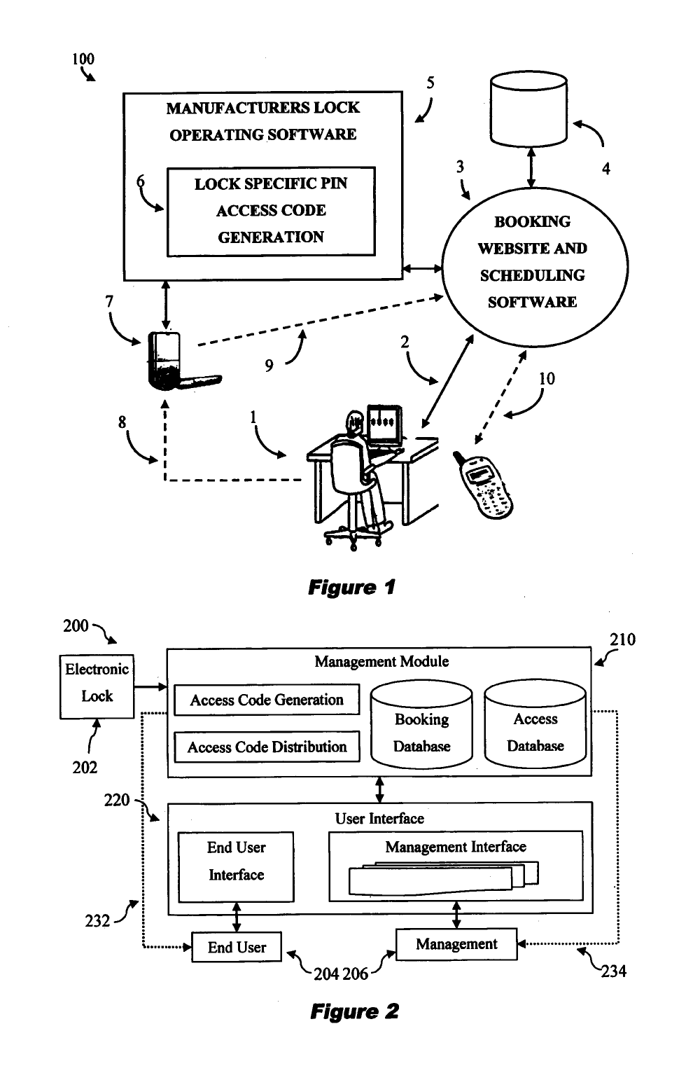

Referring now to FIG. 1, there is shown a schematic diagram of a system 100 for managing one or more access controlled locations according to an embodiment of the invention. In order to illustrate the invention, the system will be described in relation to tourist accommodation in which several rooms are available for use by guests. However it is to be understood that the system and methods could be used to manage access to accommodation such as hotels, apartments, holiday houses, caravan parks, rental houses, sporting facilities such as tennis courts, ovals, basketball courts, homes, businesses, sheds, secure storage facilities, etc. These locations (or sites, of facilities) may be single locations (eg single house or facility), or there may be several independently bookable rooms or facilities at a site (or related sites).

Each of the rooms in the tourist accommodation is provided with a standalone electronic lock. Such electronic locks have an input means such as numeric keypad or touchpad for receiving an access code, an internal clock, a processor and associated memory for verifying that an input access code is a valid code based upon the current time, and a communications interface for configuring the lock and providing status information. Such time based electronic locks are manufactured by companies such as KABA ILCO or SCHLAGE. One suitable example is the KABA Oracode 660k) which is a battery powered lock which includes a numeric key pad for entering a 6 digit access code (a manual key override is also provided).

The lock includes a clock, a processor and associated memory in which instructions are stored for generating time based access codes which can be compared or verified against an entered access code (and the current time) to determine whether to allow entry based upon the current time received from the clock. The access code (or PIN number) is generated based upon a user level, unit number, start and end date. The locks are first configured or pre-programmed with a data file which may be uploaded to the lock using an Infrared communications interface (via a Smartphone or PDA such as palm pilot running appropriate software). This data file can then be provided to third party software so that a valid access code can be generated for the lock for a predetermined time period (or periods). Alternatively the access codes may be determined according to an algorithm stored in the lock. The algorithm may then be provided to third party software to generate valid access codes. In either case, the access code generation by the third party software is completely independent of the lock.

Different users can be given different access codes allowing different access control. For example a first user could be given unlimited access for a month whilst another user guest could be given access for weekends only, and a cleaner could be given regular access during a specified time period (eg 10 am-11 am each day). The lock also includes a manual override (ie physical key), a tamper shutdown, and maintains an audit log of the last 1000 events.

It may also be possible for a user to change the access code at the lock after the first access. The changed access code would only be valid for the same time as the generated access code. The changed access code is merely recognised by the processor in the lock as an alias for the correct access code.

Returning to FIG. 1, a guest or end user 1 accesses 2 a tourist accommodation provider's booking and scheduling website 3 from an Internet enabled computer or mobile computing device. The guest views, selects, books and pays for an available room for a desired time period (the first period of time). In order to secure the booking, the guest submits appropriate personal details as required by the accommodation provider such as credit card details, deposit, address, copy of passport/license details, contact details etc. The booking details are then stored in a database 4. This database may connect or be a part of an existing tourist accommodation provider's computer reservation system, or be an external site from which the booking details may be communicated to a tourist accommodation site, such as over email. The booking website can also access the lock manufacturer's operating software and obtain a PIN access code 6 for the desired time period associated with a specific lock 7 associated (ie controlling entry) to the booked room. A booking confirmation message is then sent to the user which includes the access code and details such as maps/plans/instructions on how to locate the booked room. When the guest arrives at the location, they can go directly to their room 8 and gain access using their access code, thus bypassing any check-in desk.

The accommodation provider may require additional personal details in order to verify the identity of a guest. A verification system may be provided that is designed to assist managers in verifying the identity of a guest electronically. The verification system works by asking the user to upload, or email a scanned or photographed image of photo identification. Each type of identification is given a weighting which needs to add up to 100 points. OCR (optical character recognition) is used to automatically verify the uploaded documents match (within a %) the provided details.

If the OCR fails to match then the account is flagged and an email is sent to a staff member for manual verification. All uploaded images are transferred over a SSL connection and are watermarked for the users protection.

Communication such as booking confirmation or access information may be sent to the end user at their internet enabled computer as part of a HTTP page (or similar), to an email account provided in the booking request, or alternatively to a mobile phone 10 using a telecommunications network, such as in the form of a Short Message Service (SMS) message.

The lock logs all keypad activity in a local data store. The data store is accessed using a local device such as Smartphone or PDA using infrared or short range wireless communication, and communicated to the booking website and scheduling software. The lock may optionally be configured with a transmitter to notify the booking website and scheduling software directly that the lock has been accessed and provide access information such as the access code and access time. The access information may then be sent to the building owner or manager.

A schematic diagram 200 of the management module and user interface of the system of FIG. 1 is shown in FIG. 2. The management module may be provided in a single server or it may be provided as a distributed system with distributed components. Configuration data from an electronic lock 202 is provided to the management module 210. As outlined above, this may be by using an intermediate communication device to read the configuration information from the lock and provide it to the management module, or the configuration data may be provided independently to the lock and the management module from the lock manufacturer. There may alternatively be a direct wireless communication link between the lock and the management module.

The management module includes a management database for storing information relating to the rooms (locations) at the tourist accommodation site (eg hotel) such as information relating to bookings (current and future), lock configuration files for each of the locks, and access logs for the locks. Access to the management data base is controlled to prevent unauthorised access. The management module also includes an access code generator for determining one or more time based access codes for each of the electronic locks based upon configuration data (stored in the management database) associated with each of respective electronic locks. The management module also includes a booking module for receiving and storing a booking request from a guest (user). The booking request is for a specific room (and thus lock) for a specified time period (booking time period). Upon receipt of a booking request the booking module communicates with the access code generator to determine an access code for the desired time period. This access code may then be stored in the management database. The management module also includes an access code distribution module for sending the access code to a guest or user of the system. The access code may be provided via an interface 220 or via an alternative communication means 232 directly to the guest or via an alternative communication means 234 directly to the owner or manager. Such alternative communication means may be long range communication means such as email or SMS messages over a telecommunications network. In one preferred embodiment the access code is delivered by an application on a Smartphone.

The system also provides an interface for allowing users to interface with the management module. The interface includes an end user interface which allows end users 204 (ie guests) to search for available rooms, browse available rooms, view property details on available rooms (eg number of beds, hotel facilities, etc), and make booking requests to stay in an available room for a desired time period. The end user interface can also be used to provide booking confirmation information to the end user including the access code determined for their room.

The interface also provides a management interface to allow management 206 such as an owner, manager or staff of the tourist accommodation to access the management module. Different levels of access can be given to different management according to their roles (eg a hotel management or owner will be given greater access or control then a reservation or maintenance staff member). The management interface can be used for viewing and modifying information relating to the rooms and to determine access codes for one or more users.

The above system could be provided on a standalone computer, a server, or a distributed computing system. The database and interfaces could be built using suitable programming languages, platforms and protocols, such as Java, C++, SQL, MySQL, HTML, HTTP, XML, SOAP, etc.

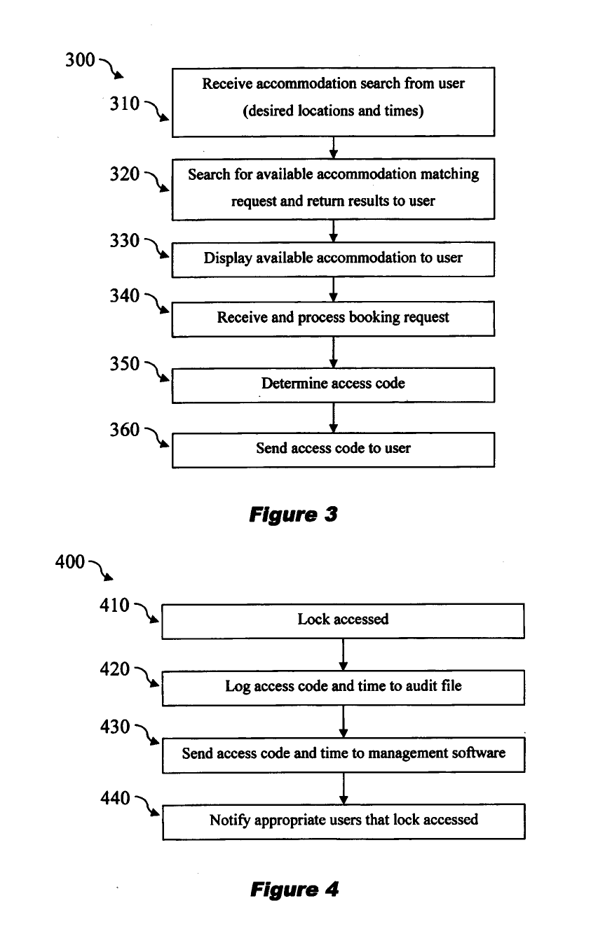

FIG. 3 is a flow chart of a method 300 for booking an access controlled location according to an embodiment of the invention. The method includes the initial or preliminary steps of receiving an accommodation search request from a user 310 including the desired location or locations and desired time period (the booking time period). The search request may include one or more desired locations, room configurations (standard, deluxe, studio, 2 bedroom apartment etc) and available facilities (e.g. pool, gym, microwave, etc) and time periods. A search is performed for available accommodation matching the request 320. This may include checking the availability of one room during the booking time period and returning information on the available rooms which match the received search request. This may be performed for a set of rooms at a single site, or a search may be performed across multiple sites to give the end user a range of choices. The available accommodation is then displayed to the user 330 using the end user interface. The user can view this information and then send a booking request for a specific room for a booking time period. The booking request is then received and processed 340 by the management module, which may include obtaining and storing relevant contact details and taking a deposit using credit card information. Relevant information is stored in the booking database. An access code is then determined 350 to allow the user to access the booked access controlled location for the booking time period, and this access code is then sent to the user 360.

The management module may also provide status reports or notification each time a lock is accessed. This is particularly useful for management of independent facilities such as holiday homes, personal residences, storage facilities, or sporting facilities. FIG. 4 is a flow chart 400 of a method for monitoring an electronic lock. The method begins with the lock being accessed 410 and the lock then storing or logging this access information 420. This access information stored would typically be the access code used and the local time (from the lock's dock). Other information could be stored such as an unsuccessful access attempt (including the incorrect access code used). This is stored in memory as an audit file and electronic locks such as the KABA Orocode 660k typically store the last 1000 events.

The stored information may be made available in a number of ways. In one embodiment, the access logs may be stored by the locks, and then transmitted or downloaded to a handheld or portable device, for example to a Palm PDA using IrDA protocols over an Infrared link between the lock and the PDA. Another suitable short range communication protocol provided in most Smartphone's is Bluetooth®. Access information could be collected by staff such as cleaners or maintenance person. The information could be collected routinely or periodically (eg on a weekly or daily round), or it could be collected infrequently or irregularly by staff going to the lock and requesting the information from the lock. To reduce power consumption at the lock a transmitter in the lock would normally be off until woken up by the request for information.

When the staff member has finished visiting the locks the access (audit) logs may then be downloaded to the management module on a local server as shown at step 430. The access information is stored in the management database. The management module may then send 440 a message to notify appropriate users that the lock has been accessed. The management database is used to store contact information for one or more users who have registered with the system that they wish to be notified that a particular lock has been accessed. The message could include the access information such as code used, time accessed, and who the code is assigned to (eg guest name, staff member, contractor). A default message format could be used or the registered user could select the format and level of detail, including when the message is sent.

The lock access information could also be provided to the management module by the lock in real time, or near real time. Alternatively the lock may store the access information and then periodically provide the information to the management module according to a schedule. In another alternative, the lock access information is provided to the management module upon request.

In order to keep costs down, and save power, the access information is preferably sent to the management module using a short range communications means. That is from the lock to a nearby receiver or a receiver in a computing device located in an administration room, or common room such as a reception area. Typically this distance would be under 50 m and in many cases would be much less, especially if a network of receivers were used in conjunction with the locks. This transmission may be using a short range wireless transmission protocol. Such transmission protocols include Bluetooth®, ZigBee, WiFi, RFID, IEEE 802 standards such as 802.15.4-2006 and infrared Data Association (IrDA) protocols.

The information may be transmitted to a receiver permanently located near the lock, for example in a corridor so that multiple locks can be simultaneously monitored. The receiver could be mains powered and could be physically connected to a local server (or computer), or it could establish a connection using wireless means. The local server may host the management module, or otherwise be capable of sending the information to a remote server hosting the management module. Alternatively the local server could store registered users for each lock and then send a notification message to them upon receiving lock access information.

The notification message is sent to the one or more registered users over a long range communications means by the management module. The message may be sent as a short message service (SMS) message over a telecommunications network or the message may be sent as an electronic mail message over the internet.

In the interests of reducing maintenance requirements, maximising battery life, and keeping the lock as simple as possible, many electronic locks avoid the inclusion of long range or power intensive communication interfaces or communication means. For example the KABA Orocode 660k only includes an infrared (IR) communications link for uploading of configuration data to the lock, and to allow status information such as audit logs or access logs to be retrieved or downloaded from the lock.

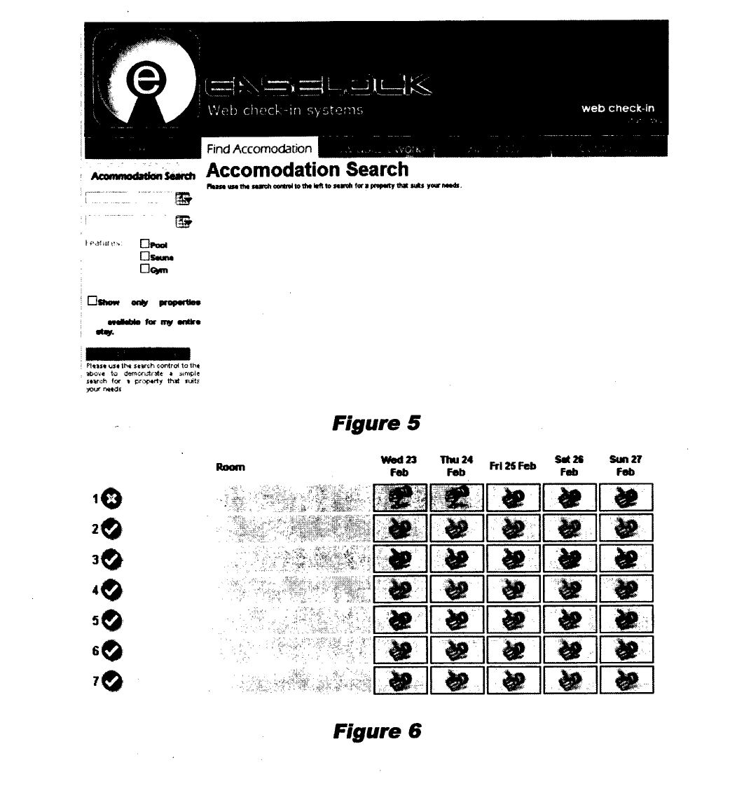

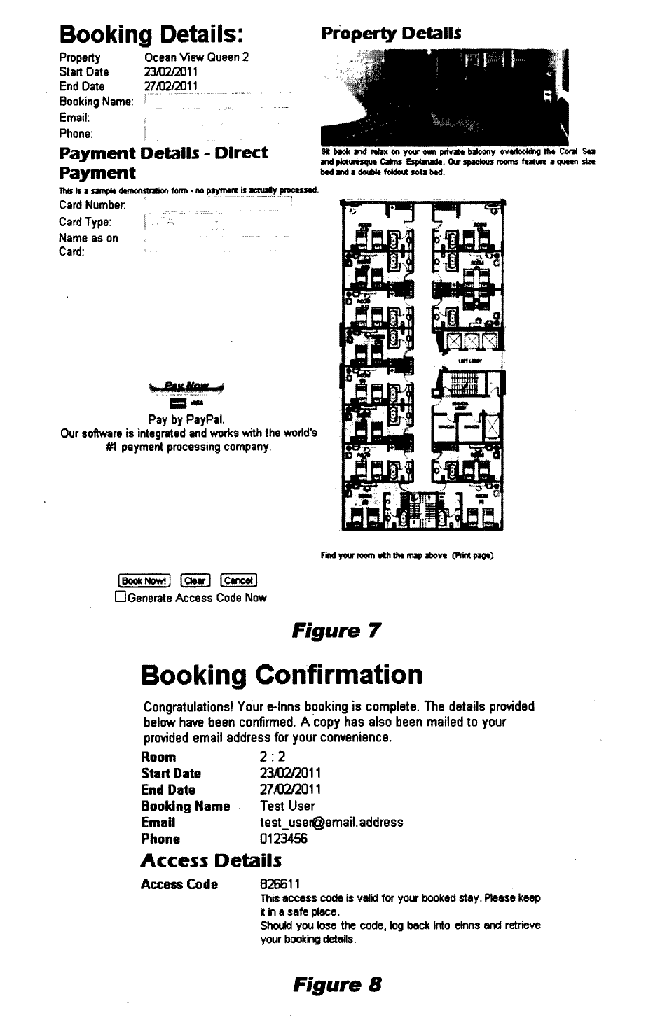

To exemplify the operation of the invention the user interface and management interface are illustrated in FIGS. 5 to 13. FIG. 5 is a user interface for performing an accommodation search. The user enters dates (eg 23 February to 27 February) and any other specific requirements and the search is executed and the results are displayed in FIG. 6. In this case there are seven rooms but only rooms 2 to 7 are available as room 1 is occupied for the first two days of the search period. The user selects room 2 (by selecting the tick next to the 2) and a description of the room is provided along with fields for making and sending a booking request (FIG. 7). The user fills out and sends the booking request which is then processed. FIG. 8 displays a booking confirmation message which is displayed to the user and which includes an access code for accessing the booked accommodation during the booking period. The user can then use this booking code to access the room during the specified dates without having to check-in or otherwise communicate with the building owner or management.

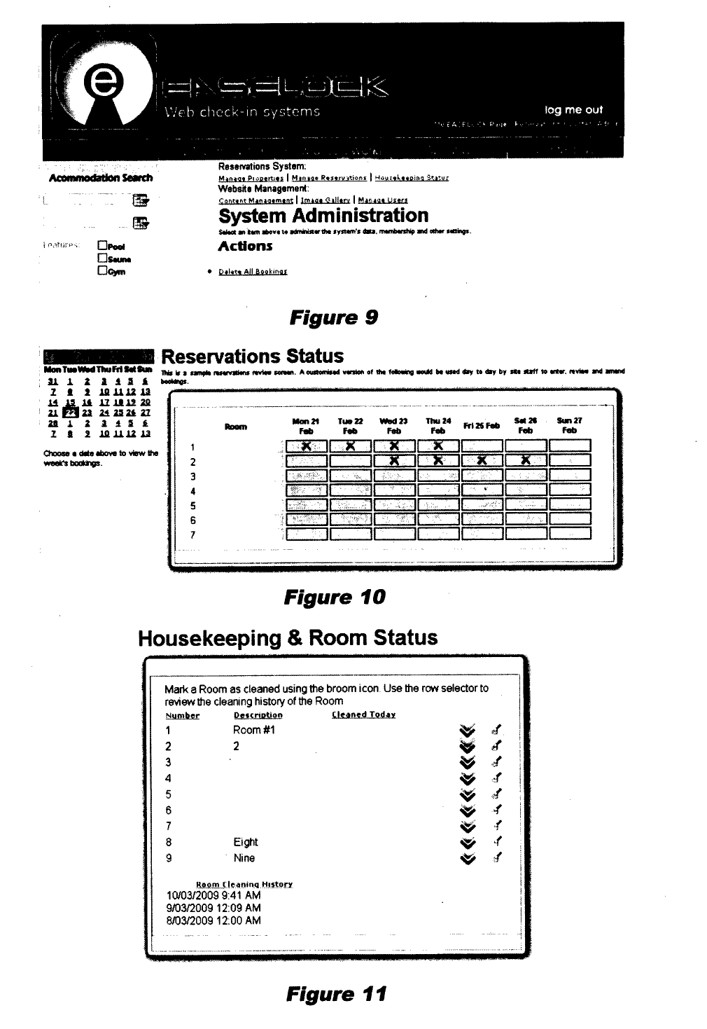

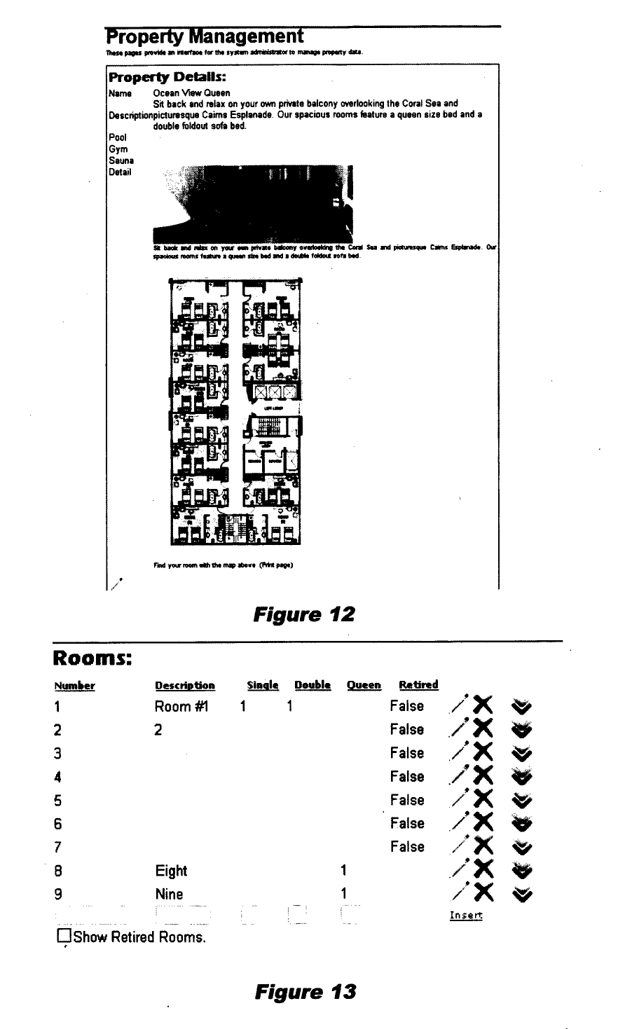

A home screen for an embodiment of the management interface is illustrated in FIG. 9. This allows an owner or manager to check and modify reservations, control the website and administer the system. The manager can click a reservations status link to obtain a reservation status report for a date period of interest. FIG. 10 illustrates a reservation status record which illustrates the booking in rooms 1 and the new booking made above in respect of room 2. The management system also allows the manager to view a housekeeping and room status report which is illustrated in FIG. 11. The manager can click on a room and obtained a detailed cleaning history of when and at what time the room was cleaned based upon lock access information. The management interface also allows the manager to modify or configure the property details of specific rooms or summary information. FIG. 12 displays the property details for a room and allows the manager to control the layout of the html page that a user will view in relation to the room. FIG. 13 displays the summary information for all rooms and is laid out as an editable table in which rows correspond to rooms and columns correspond to fields such as description and number and types of beds in each of the managed rooms.

The management interface also allows the manager to perform system administration and control various reporting features, such as when and to whom reports are sent. Email addresses and/or mobile phone numbers can be stored for registered users of the system, and reports can be emailed or sent as text message when specified events occur, or at regular time periods. For example the system could be configured to send an email or text message to the owner each time the management module records that a lock is accessed (or successfully accessed) or when a booking is made. Similarly the booking schedule for the next week and cleaning history for the past week could be emailed or otherwise sent to the owner at the start of each week. In this way an owner can monitor and manage the system with minimal intervention, and without having to operate a reception front desk. In some embodiments a computer could simply be provided at the front desk, to allow guests who do not have a booking to make one on arrival and be issued with an access key. Such an approach would only need to be used by those people who arrive without having made a booking or it could be used by a person who wishes to amend their booking, such as stay an extra day.

The above embodiment relates to a tourist accommodation site such as a hotel having a plurality of rooms and provides a basic and easy to use property management system. Such a simple booking and scheduling system is particularly advantageous for owners or operators of small facilities such as small apartment complexes, holiday homes, rental accommodation,

The user interface could be provided via the web to a client computer or mobile phone, or a dedicated client application (eg an iphone app) could be developed to allow users and managers to interface with one or more management modules residing on remote servers.

As discussed above, the electronic lock of the preferred embodiment is standalone and battery powered with a passive communication interface allowing interrogation of the access log an uploading of the access code data file. Also as mentioned above it may be desirable in some instances to provide an independent electronic lock with a transmitter to allow access information to be sent to a management module (possibly via another component such as a receiver and local server which are not power limited).

The transmitter could transmit using lower power communications protocols such as Bluetooth®, ZigBee, WiFi, RFID, IEEE 802 standards such as 802.15.4-2006 and Infrared Data Association (IrDA) protocols. Such a lock could be provided by integrating an off the shelf communications or data transmission chip to an existing lock or a system on a chip could be used in the lock which includes a processor and memory including the ZigBee (or other) stack, to which the lock operating firmware could be uploaded. Example chips include Texas Instruments CC2430 or CC2431 chips, or Analog Devices 9861BCZ chips. In order to maximise battery life the transmitter could be programmed or configured to only transmit (and not receive) and could be further programmed to only transmit access information in response to an access attempt or a successful access attempt. Alternatively it could be programmed to transmit the information at a scheduled time (eg 11 am each day). In another alternative the transmitter could also be configured to transmit and receive, and only transmit upon receiving a request. The locks could also be configured to transmit other information such as configuration information as required.

In a further embodiment, a lock configured with a transmitter could be used to allow a user to select or change their access code, or to enrol other users on their lock. Prior art locks allow a user to enter a new access code or user PIN whenever they access the lock using their assigned access code. They can also enrol additional users of the lock under their access code. By inclusion of a low power transmitter in the lock, a communication request could be sent to the lock requesting that an existing valid access code be associated with one or more user specified access codes (user PIN). This would allow the user to select their own access code (user PIN) which they may find easier to remember. This option could be provided using the user interface when making a booking request, or after a booking has been made, by logging back into the system using the user interface and modifying their booking. Alternatively if they receive their access code via their mobile phone they could respond to the SMS with a new PIN, and the management module could receive and process this PIN by communicating with the lock.

Similarly, the ability to enrol a further user could be added. This system would require the management module to be in constant or at least regular communication with the locks, and would increase the power requirements and thus reduce the battery life of the locks. This could be minimised however by only enabling communication at predetermined or set time periods (eg 11:30-11:40 each day). For example each lock in a facility could be assigned a different time period. During that agreed or assigned time period the lock would awaken the transmitter and receiver and request or listen for an update. Access logs could be sent to a local server, and access code change requests could be received. Further if a user has changed their access code (ie to a user PIN) then this event or information can be transmitted to the management module.

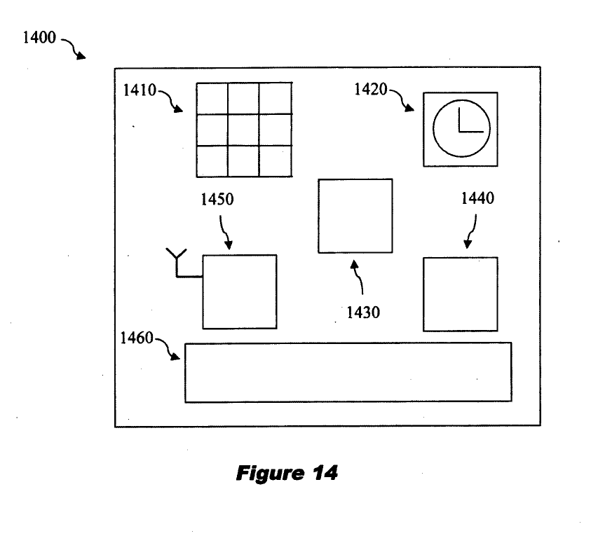

FIG. 14 is a schematic diagram 1400 of an electronic lock according to an embodiment of the invention. The lock includes an input means 1410 for receiving an access code, a clock module 1420; a processor 1430 and associated memory 1440, a transmitter 1450 and a locking mechanism 1460. The various components may be separate components or integrated as required. For example the memory may store instructions (firmware) for execution by the processor to operate the input means and/or the transmitter. The input means may be a numeric keypad, and may include a communications interface such as an RF or IR based interface for receiving configuration information or downloading access (audit) logs. The transmitter may be configured with a wireless protocol such as ZigBee and be used to transmit messages that the lock has been accessed. Additionally the transmitter (possibly in conjunction with the processor and memory) could be used as the communications interface and be used to receive configuration information or other requests, and to provide status information (eg access logs) and to transmit a message when a lock has been accessed. The locking mechanism includes a mechanism under the control of the processor for actuating the deadbolt or latch from a locking to an open position (and back again).

Whilst the main embodiment described above relates to a tourist accommodation site it is to be understood that the systems and methods may be used to manage access to a range of accommodation and facilities such as hotels, apartments, holiday houses, caravan parks, rental houses, sporting facilities such as tennis courts, ovals, basketball courts, homes, businesses, sheds, secure storage facilities, etc.

The system and method described allows the management modules and user interface to be independent of the locks, as only the configuration files are required in order to ensure that access codes can be generated. The locks can be preconfigured in a factory, or upon installation or during a maintenance visit, and these configuration files can then be sent or uploaded to the management module (ie stored in the management database for use by the access code generator). In this way the management modules and interface can be hosted on a server remote from the tourist accommodation site. This can then be accessed by management or users, and integrated into other systems such as accommodation search engines, hotel chain booking systems, online travel agencies, online booking agencies, and global distribution systems. In such cases, upon a booking being made, the booking details can be communicated to the actual accommodation provider. In other embodiments the management modules are in communication with the locks. The management modules may be hosted on a server at the accommodation facility and be in direct communication with locks. In other cases the management modules may be remote and may communicate via other intermediary systems such as relays systems including receivers located near the lock and in communication with a server. Alternatively a handheld device such as a Smartphone or PDA may be physically taken to each lock (where it communicates with a lock over a short range means such as IR) and the information then uploaded to the management modules (possibly via an intermediate server).

The system and methods described herein provide numerous advantages over prior art systems. The system delivers a secure, scalable, real-time solution for hotel or accommodation management that improves the guest experience. Further it removes the need for front desk-receptionists and lowers overall costs though savings in lost keys, cards, staff numbers, and global footprint. The system integrates well with online check in systems provided in the tourist and accommodation sectors and provides a 24 hour remote automatic check-in desk. Owners have the opportunity to increase occupancy rates, by targeting current frustrations, delays and inconveniences to end users as guests are saved the hassle of carrying around extra keys or access cards. The system can also be easily configured to provide information in a variety of languages, and thus be may increase tourism from a range of non English speaking countries. Further the system has low maintenance requirements and therefore low costs.

The system may also be used by home or business owners to control access to their home or business. The system delivers benefits such as ensuring that they are never locked out of their own home. Further the owner never needs to worry about carrying around, forgetting, losing keys, making arrangements for employees, family members to have their own keys. Further the system can be used to allow immediate family, extended family, friends, cleaning lady, employees, and colleagues to have their own unique access codes which you can be controlled or revoked as required. Similarly one time access codes can be generated from anywhere in the world to let a plumber, tradesperson, visitor, delivery person into the home or business as required. The owner can also audit the lock at any time to see who and when the lock has been accessed, or similarly the system can be configured so the owner receives a text message alerts to know when all or a specific user has accessed the location (e.g. a child, a cleaner, or an employee). The system is both convenient and secure, and the user interfaces can be accessed remotely so that the owner can remotely monitor the site when they are not at home.

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. Software modules, also known as computer programs, computer codes, or instructions, may contain a number a number of source code or object code segments or instructions, and may reside in any computer readable medium such as a RAM memory, flash memory, ROM memory, EPROM memory, registers, hard disk, a removable disk, a CD-ROM, a DVD-ROM or any other form of computer readable medium. In the alternative, the computer readable medium may be integral to the processor. The processor and the computer readable medium may reside in an ASIC or related device. The software codes may be stored in a memory unit and executed by a processor. The memory unit may be implemented within the processor or external to the processor, in which case it can be communicatively coupled to the processor via various means as is known in the art.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A system for managing one or more access controlled locations, the system including
one or more electronic locks for controlling access to one or more locations, each of the one or more electronic locks including:
input means for receiving an access code;
a clock;
a processor and associated memory for verifying a received access code based upon the current time received from the clock;
a communications interface for configuring the lock and providing status information;
a management module for managing access to each of the one or more electronic locks, the management module including:
a management database for storing information relating to the one or more locations, the information including bookings, lock configuration and lock access;
an access code generator for determining one or more time based access codes for each of the one or more electronic locks based upon configuration data associated with each of the one or more electronic locks;
a booking module for receiving and storing a booking request from a user for access to a location for a booking time period, the booking module obtaining an access code from the access code generator in response to a received booking request;
an access code distribution module for sending an access code to a user;
a user interface for allowing one or more users to interface with the management module, the user interface including:
an end user interface for receiving a booking request from a user for access to one of the one or more locations for a booking time period;
a management interface for viewing and modifying information relating to the one or more locations and for generation of access codes to one or more users.

2. The system of claim 1 wherein the input means is a keypad or touch screen.

3. The system of claim 1 wherein the associated memory stores a list of access codes and the times they are active.

4. The system of claim 1 wherein the associated memory stores program instructions to cause the processor to check if an access code is valid according to a predetermined algorithm.

5. The system of claim 1 wherein the communications interface is configured to provide status information on request.

6. The system of claim 1 wherein the access code generator of the management module stores the same list of access codes and times as the lock.

7. The system of claim 1 wherein if the access code is generated according to an algorithm the access code generator of the management module stores the same algorithm.

8. The system of claim 1 wherein each of the one or more locks stores lock access information.

9. The system of claim 1 wherein lock access information is provided to the management module upon request via the communications interface.

10. The system of claim 1 wherein the management module associates at least one registered user with one of the one or more electronic locks, and sends a lock access report to an associated registered user upon receipt of lock access information for the lock.

11. A method for booking an access controlled location, wherein access to the location is controlled by an electronic lock, the method including the steps of:
receiving a booking request for the access controlled location for a booking time period from a user;
generating an access code for the user to allow the user to access the booked access controlled location for the booking time period; and
sending the access code to the user.

12. The method as claimed in claim 11, wherein the access controlled location is selected from the set of one or more available access controlled locations for the booking time period, and the method includes the preliminary steps of:
receiving a search request for access to a location for a booking time period from a user; and
checking the availability of one or more access controlled locations during the booking time period and returning information on one or more available access controlled locations which match the received search request.

13. A method for monitoring an electronic lock which allows access to a location using a time based access code, the method including:
retrieving to a management module access information from an electronic lock, the electronic lock logging access information each time the electronic lock is accessed, wherein the access information relates to the access code and access time; and
sending a message including the access information to one or more registered users using contact information stored in the management module.

14. The method as claimed in claim 13 wherein the access information is retrieved by the management module using a short range communications means.

15. The method as claimed in claim 13 wherein the message is sent to the one or more registered user over a long range communications means.

16. A computer readable medium for performing the method of any one of claims 11 to 15.

17. An electronic lock for controlling access to a location, the electronic lock including:
input means for receiving an access code;
a clock;
a processor and associated memory for verifying a received access code based upon the current time received from the clock;
a transmitter for sending access information including the access code and access time to a management module upon the lock being accessed.

18. The electronic lock as claimed in claim 17 wherein the input means further includes a receiver for receiving configuration information and the memory contains instructions for generating valid access codes based on the configuration information and current time for comparison with a received access code.

19. The electronic lock as claimed in claim 17, wherein the transmitter uses a short range wireless transmission protocol.

20. The electronic lock as claimed in claim 17 wherein the lock further includes a receiver for receiving a user access code to replace a valid access code.
